(19) United States
(12) Patent Application Publication
(10) Pub. No.: US 2005/0107929 A1
(43) Pub. Date: May 19, 2005

(54) Method, device and computer product for updating data of a control device

(75) Inventor: Andreas Haydn, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: BAYERISCHE MOTOREN WERKE AG, Munchen (DE)

(21) Appl. No.: 10/786,169

(22) Filed: Feb. 26, 2004

Related U.S. Application Data
(63) Continuation of application No. PCT/EP02/07819, filed on Jul. 13, 2002.

(30) Foreign Application Priority Data
Sep. 1, 2001 (DE) 101 43 030.2

(51) Int. Cl. G01M 17/00

(52) U.S. Cl. 701/35; 701/29

(57) ABSTRACT

The process provides for storing and/or updating control unit data, such as a program code for sequence control characteristic diagram control, of at least one control unit of a motor vehicle, which are stored in a memory, such as particularly a solid state memory, assigned to the control unit. To shorten the time required for storing and/or updating such control unit data of one or more control units the control unit data are stored in and read out of a data carrier. They are then stored in the memory assigned to the control unit.

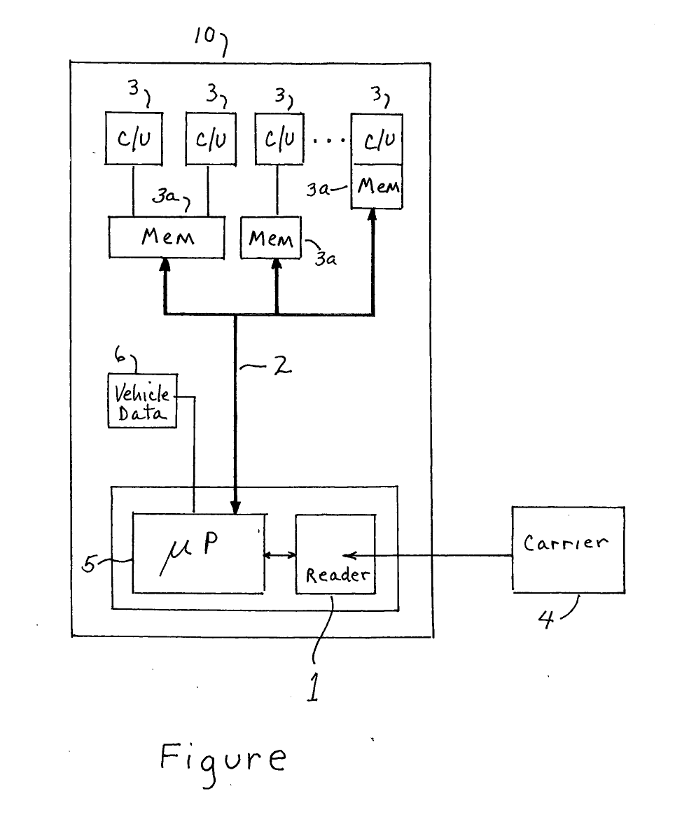

### CROSS-REFERENCE TO RELATED APPLICATIONS

This application is a CONTINUATION of PCT Application No. PCT/EP02/07819 filed on Jul. 13, 2002.

### BACKGROUND AND SUMMARY OF THE INVENTION

This application claims the priority of German patent document 101 43 030.2, filed 01 Sep. 2001 (01.09.2001), the disclosure of which is expressly incorporated by reference herein.

The invention relates to a method and apparatus for storing control unit data, such as a program code for sequence control or characteristic diagram control of a control unit in a vehicle.

Modern vehicles, particularly passenger cars, normally have a plurality of control units and one or more vehicle communication or computer buses (I/K bus, MOST bus, CAN bus, etc.) which form a communication network with the control units. Control units, such as an ABS control unit or a control unit for the characteristic-diagram-controlled engine timing, are generally sequence-controlled by control unit software; that is, the control unit processes the output quantities of the sensors assigned to it and controls actuators as a function of the output quantities and of the sequence control implemented by the control unit software.

When dealing with damage caused by an accident, in the case of a servicing or within the scope of a “call-back action”, further storing and/or updating of control unit data by the authorized dealer may be necessary for the operation of one or more control units. Conventionally, such storing and/or updating is implemented by way of a diagnostic interface of the motor vehicle, which provides a relatively slow communication interface to the control units. Since both the number of the control units and the length of the control unit data (or of the software codes of the control units) is increasing continuously, the time required for storing and/or updating control unit data by way of this slow interface is steadily increasing as well. As a rule, this time expenditure is billed either to the customer or to the vehicle manufacturer.

It is therefore an object of the invention to shorten the time required for storing and/or updating the control unit data of one or more control units of a motor vehicle.

This and other objects and advantages are achieved by the method and apparatus according to the invention, which uses a vehicle communication channel that is faster in comparison to the diagnostic interface of the motor vehicle, for transmitting control unit data stored on a data carrier into the corresponding control unit(s) or their assigned memories.

Other objects, advantages and novel features of the present invention will become apparent from the following detailed description of the invention when considered in conjunction with the accompanying drawings.

### BRIEF DESCRIPTION OF THE DRAWINGS

The single Figure of the drawing is a schematic block diagram of a system for implementing the data entry method according to the invention.

### DETAILED DESCRIPTION OF THE DRAWINGS

In a preferred embodiment of the invention, the control unit data are transmitted by way of a media reader 1, such as a CD-ROM reader contained in a vehicle navigation system and/or a DVD or CD-ROM reader of an audio and/or video system of a vehicle 10, together with an optical or electric vehicle communication bus 2 for storing and/or updating into the control unit or units 3. When such a reader is used, the data to be stored or updated, according to the invention, are stored on a data carrier 4, such as a CD-ROM or DVD, and are read out by way of the reader or the drive 1. This approach permits a fast, personnel-effective and uncomplicated storing or updating of control unit data, for example, by shop personnel.

It is also possible to offer data carriers to the vehicle owner, on which additional features, such as comfort features, safety features or performance features are stored in the form of software codes. This software code can, for example, influence the control characteristics of a control unit, a vehicle computer, or other devices or equipment of the vehicle. As a result, the customer, the vehicle owner or the shop would be able subsequently to activate or form “optional equipment” with respect to the software. A comfort feature may be, for example, a software-related improvement or the possibility of a hydraulic or pneumatic adjustment of the shock absorbers of the chassis tuning. A safety feature might be, for example, a software implemented improvement of ABS control, or a selective technique for controlling the brake cylinders of each vehicle wheel to stabilize the vehicle in critical driving situations. An example of a performance feature would be a software-related improvement or change of the engine power or engine characteristic.

As used herein, the term “control unit data” refers particularly to program codes for sequence control of at least one control unit and/or for characteristic-diagram control by a control unit. “Characteristic-diagram control” is a sequence control for a control unit which takes into account two and more operating parameters. According to the invention, the control unit data are stored in a memory 3a assigned to the respective control units, such as a solid state memory which is not necessarily arranged in the control unit. For this purpose, this may also be a data memory to which two or more control units have access.

In one embodiment of the invention, the control unit data are read out of a data carrier 4 which, in addition to the control unit data, also has navigation data for a use by a navigation system or tracking system of the motor vehicle. Such a data carrier with navigation data (for example, a CD or DVD) is normally left for the operation of a navigation system situated in the vehicle. Since the navigation data, such as street data, etc., become outdated relatively quickly, such a data carrier is normally exchanged at regular intervals for an up-to-date data carrier (for example, every six months) within the framework of a subscription.

In another embodiment of the invention, the control unit data are read out of an optical data carrier, such as a CD-ROM or compact disk, a DVD or Digital Versatile Disk, a holographic data memory or the like, or out of an electric data carrier, such as a fixed disk, a solid state memory, a flash memory, a chip card, an EE-PROM, or the like. Such easily transportable data carriers with a high storage capacity can be “coupled” to the vehicle communication bus 2 relatively easily and cost-effectively by way of corresponding readers 1 or interfaces for the storing and/or updating of control unit data.

According to the invention, the reading-out and/or storing may be performed under the control of a storing or updating system, such as particularly a program-controlled microprocessor 5. This permits the software-related implementation of cryptographic measures and measures ensuring data integrity.

According to another embodiment of the invention, the control unit data, which are stored in the control unit and are to be updated, and the data stored on the data carrier, have in each case been provided with a characterizing feature, such as a date and/or a version designation. Also, older control unit data can be updated or replaced by newer control unit dates.

According to a further feature of the invention, the storing or updating system accesses the vehicle data 6, such as data characterizing the particular vehicle and/or vehicle type, and then reads those control unit data out of control unit data stored on the data carrier 4 which were intended for the vehicle determined by means of the vehicle data or for its control units 3, for the storing and/or updating.

The control unit data stored on the data carrier may have a plurality of data sections, each of which represents updates or replaces control unit data of another control unit.

The storing or updating system for storing and/or updating the control unit data according to the invention, reads out and processes at least partially one storing and/or updating instruction stored on the data carrier, such as a storing and/or updating sequence control. These measures permit a largely automated and reliable software-controlled updating, particularly when using a program-controlled microprocessor 5. In addition, the control unit data stored on the data carrier may be coded or provided with control data, such as a check sum or the like, which protect against falsification.

According to another embodiment of the invention, the storing or updating system decrypts the control unit data read out of the data carrier or checks their integrity, and causes an updating or replacement only when they are correctly decrypted or have integrity.

The control unit data stored in the control unit may include information characterizing their authenticity and/or version, such as particularly control data.

According to another feature of the invention, the storing and/or updating of the control unit data may be carried out only after a corresponding release by an authorization system, which is preferably controlled by the vehicle manufacturer.

According to still another feature of the invention, the vehicle identification number of the corresponding vehicle and/or updating instructions characterizing the control unit data of the concerned vehicle may be stored or documented in a computer data bank, preferably with the vehicle manufacturer. In this manner, it is possible largely to prevent unauthorized persons from performing software-related interventions in the electronic vehicle system, to the detriment of safety and the useful life of the vehicle.

According to the invention, it is suggested to further develop a known system for updating of control unit data stored in at least one control unit of the motor vehicle, such as particularly a program code for the sequence control of the control unit and/or for the characteristic diagram control, in such a manner that the system utilizes one or more of the above measures according to the invention.

The invention also includes a computer program product, which can be loaded directly into the internal memory of an updating system, such as particularly a digital computer, in such a manner that it has program sections which cause the implementation of one or more of the preceding measures according to the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A process for storing and updating control unit data, including a program code for the sequence control or characteristic diagram control of at least one control unit of a vehicle, in a memory assigned to the control unit; said process comprising:
a storing or updating system reading the control unit data out of a data carrier; and
the storing or updating system causing control unit data to be stored in the memory assigned to the control unit.

2. The process according to claim 1, wherein, in addition to the control unit data, said data carrier also has stored therein navigation data for use by a navigation system or tracking system present in the motor vehicle.

3. The process according to claim 1, wherein the data carrier comprises one of an optical data carrier, a CD-ROM, a compact disk, a DVD, a holographic data memory, an electric data carrier, a fixed disk, a solid state memory, a flash memory, a chip card and an EE-PROM.

4. The process according to claim 1, wherein the process is carried out under control of a program-controlled microprocessor.

5. The process according to claim 1, wherein:
the control unit data are provided with a characterizing feature comprising at least one of a date and a version designation; and
older control unit data are updated or replaced by newer control unit data.

6. The process according to claim 4, wherein the storing or updating system accesses vehicle characterizing data and reads out from a plurality of control unit data stored on the data carrier, control unit data for a vehicle indicated by means of the vehicle characterizing data or for its control units, for storing and/or updating.

7. The process according to claim 1, wherein control unit data stored on the data carrier have a plurality of data sections, each of which represents updates or replaces the control unit data of a respective control unit.

8. The process according to claim 4, wherein the data carrier has stored therein a storing and/or updating instruction for storing or updating sequence control.

9. The process according to claim 1, wherein at least one of the following is true:
the control unit data stored on the data carrier have been encrypted; and
the control unit data have been provided with control data which protect against falsification.

10. The process according to claim 9, wherein a storing or updating system performs at least one of the following:
it decrypts the control unit data read out of the data carrier;
it checks the integrity of control unit data readout of the data carrier;
it causes an updating or replacement of control unit data when the decrypting is correct or when integrity is determined.

11. The process according claim 1, wherein control unit data stored in a control unit include have information characterizing their authenticity or version.

12. The process according to claim 1, wherein the storing and/or updating of the control unit data is carried out only after a corresponding release by an authorization system, the authorization system preferably being under control of a vehicle manufacturer of the corresponding vehicle.

13. The process according to claim 1, wherein one of a vehicle identification number and data characterizing the control unit data of a corresponding vehicle are stored in a computer data bank.

14. A system for storing and/or updating control unit data, including a program code for sequence control or characteristic-diagram control of at least one control unit of a motor vehicle, which are stored in a memory assigned to the control unit, said system comprising:
means for reading the control unit data out of a data carrier; and
means for the storing or updating system causing control unit data to be stored in the memory assigned to the control unit.

15. A computer program product which can be loaded directly into internal memory of a storing or updating system, including a digital computer, wherein it has program sections for implementing a process according to claim 1, when the product is running on the storing or updating system.

16. A method of inputting control unit data into a control unit in a vehicle that has an on board system including a reader unit which can read data from a removable data carrier, and a data bus that couples said on board system with said control unit; said method comprising:
said reader unit of said on board system reading the control unit data out of said data carrier;
communicating said control unit data to said control unit via said data bus; and
storing said control unit data in a memory associated with said control unit.

17. The method according to claim 16, wherein said on board system comprises one of a vehicle navigation system, an audio system and a video system.

18. The method according to claim 16, wherein said carrier comprises one of a CD-ROM, a DVD, a compact disk, a holographic data memory, a fixed disk, a solid state memory, a flash memory, a chip card and an EE-PROM.

19. The method according to claim 16, wherein:
said carrier contains control unit data applicable to a plurality of vehicles; and
said reading step is controlled by a microprocessor which reads vehicle characterizing information from a memory, and causes said reader unit to read from said carrier, only control unit data that are applicable to particular vehicle control units.

20. The method according to claim 19, wherein said characterizing information is stored in a memory maintained by a manufacturer of the vehicle.
